(19) United States
(12) Patent Application Publication
(10) Pub. No.: US 2026/0070486 A1
(43) Pub. Date: Mar. 12, 2026

(54) Principle of Operation of Adaptive Acoustic Alarm System for Quiet Vehicles

(71) Applicant: LIMITED LIABILITY COMPANY "KAR SYSTEMS", Moscow (RU)

(72) Inventors: Dmitry Valerievich KUZNETSOV, Moscow (RU); Alexander Alexandrovich SEVASHOV, Odintsovo (RU); Evgeny Valerievich TALACHEV, Moscow (RU); Anton Olegovich SUBBOTKIN, Moscow (RU); Timofey Alexandrovich MAKSIMENKO, Moscow (RU)

(21) Appl. No.: 18/575,041

(22) PCT Filed: Jun. 1, 2023
(86) PCT No.: PCT/RU2023/000165

§ 371 Date: Dec. 28, 2023

(30) Foreign Application Priority Data
May 23, 2023 (RU) 2023113277

(51) Int. Cl. B60Q 5/00; G10K 15/02

(52) U.S. Cl. CPC B60Q 5/008; G10K 15/02

(57) ABSTRACT

This invention generally refers to the technology of sound emission in a vehicle to inform a person in the area surrounding the vehicle that the vehicle is moving or about to start moving in the direction of movement, for example forward or backward. More specifically, this invention refers to a method of sound alerting for vehicles (V) with a low noise level. A method of sound alerting for low-noise vehicles (TS), containing the stages during which:

a) using external devices installed on the vehicle, input data parameters are obtained which include at least the following information: on activation/deactivation of the vehicle, information on the selected mode of movement of the vehicle, information on the vehicle speed, information on the geolocation zone in which the vehicle is located, information on the current time of day, information on the position of the visibility value controller;

b) a sound data packet containing at least two event sounds, a parking sound, a forward motion sound consisting of four separate layers, and a reverse movement sound is received from the AVAS (Acoustic Vehicle Alert System) computing unit;

c) the received data are processed at the stages a) and b) using a processing module, as a result of which a sound signal is generated for the alert mode depending on the values of the data of the input parameters and the sound data packet, and the alert volume level depending on information on the current time of day, information on the geolocation zone in which the vehicle is located, and the information on the position of the visibility value controller;

d) a sound alerting is carried out using a vehicle speaker system with a set volume and a set sound mode, determined at step c).

### PERTINENT ART

This invention generally refers to the technology of sound emission in a vehicle to inform a person in the area surrounding the vehicle that the vehicle is moving or about to start moving in the direction of movement, for example forward or backward. More specifically, this invention refers to a method of sound alerting for vehicles (V) with a low noise level.

### STATE OF ART

Traffic of vehicles has historically been a source of constant regulation of congestion, pollution and noise. In the early years, vehicles simply moved much faster than horse-drawn ones, and pedestrian traffic had to adapt, therefore intersections and traffic lights appeared from this need. Silencers and pollution control were developed to reduce noise and smog, and now external safety systems are regulated as well.

Electric vehicles (EV) and hybrid vehicles (HV) in electric mode are often too quiet to be heard in advance, especially at low speeds (being operated in urban environment). UN Regulation No. 138 classifies such vehicles as Quiet Road Transport Vehicles (QRTV). To reduce the risk of pedestrian knockdown, especially for the visually impaired persons, an Acoustic Vehicle Alert System (AVAS) has been introduced, which warns vulnerable road users of the approach of hybrid/electric vehicles. It is necessary that electrified vehicles that can back away or at least move in one forward gear with idle internal combustion engine shall meet certain “sound”requirements.

From the state of art, the information source RU 2513092 C1 is known, it has been published on Apr. 20, 2014 and it discloses an installation for emission of vehicle alert sounds, which emits an alert sound to inform people about the vehicle presence. The installation contains a sound emission device and an alerting sound control device. The alerting sound control device is designed with the ability to operate the sound emission device so that it selectively emits the movement alert sound depending on the nature of the movement (start, forward, reverse), the speed of the vehicle (the frequency of the sound increases as the speed increases), the location of the vehicle (movement in a residential area), or by means of a manual operation.

The disadvantages of this well-known solution are as follows: a sound volume level is maintained a constant when moving forward regardless of speed, which does not comply with FMVSS No. 141 (Minimum sound requirements for hybrid and Electrified vehicles in the USA), and manual increasing the volume of alert sounds with a significant background noise level.

Also known from the prior art the information source US 2016118037 A1 is known, which has been published on Apr. 28, 2016 and discloses a device and a method for emitting an alerting sound of a quiet vehicle. The device comprises a memory unit which is configured to store a database of sounds, and a controller that selects an alerting sound depending on the speed.

A CAN bus can be used as a communication interface with a vehicle, which provides the information about the vehicle speed. The formation of alerting sounds is based on an exponential increase of the frequency band of the alerting sound depending on the speed.

The disadvantages of this well-known solution is the use of only narrowband signals for sound generation.

In addition, the patent U.S. Pat. No. 9,189,452 B2 is known from the prior art, which has been published on Nov. 17, 2015 and which discloses a device and a method for generation of artificial noises during vehicle movement, as well as a computer program for implementation of this method. Environmental conditions, objects and/or other road users are recorded by an environmental sensor. Depending on this and, if necessary, on the internal information of the vehicle, road noises with special properties are generated. In this way, other road users can be warned about quietly moving vehicles.

Traffic noises are formed depending on the surrounding conditions and/or other road users, as well as internal information from the vehicle.

The disadvantages of this invention are the need for additional sensors to obtain information about the surrounding environment (the presence of pedestrians, road signs, etc.).

Also, an information source U.S. Pat. No. 5,635,903 A is known from the prior art, which has been published on Jun. 3, 1997, and which describes a generator of simulated sounds for electrified vehicles.

In this solution, sensors for vehicle start, speed, rpm, accelerator pedal position and ambient noise sensor are used to determine the driving mode. This information is used for selection of sounds (movement start, movement at a constant speed) and their volume to generate a sound of simulation of the movement mode and its subsequent reproduction through a loudspeaker. A simple frequency oscillator, a sound synthesizer, or a digital signal processor (DSP) can be used as a sound source.

The disadvantages of this well-known solution include the absence of an algorithm for increasing/decreasing the level of volume of the emitted signal depending on background noise.

Also from the prior art the information source U.S. Pat. No. 10,953,794 B2 is known, which has been published on Mar. 23, 2021, and which describes an alerting device for vehicles.

The known solution controls the level of the sound pressure level of the emitted signal depending on the state of movement of the vehicle (by its increase at the beginning of movement and until the vehicle reaches a preset speed) and consists of a control unit and a loudspeaker. The control unit receives signals on the position of the brake and accelerator pedals, the gear lever, speeds of individual vehicle wheels, and signals from the engine control unit to determine the nature of movement. To control the level, a speed range is set in which a sound signal is emitted, as well as parameters that determine the nature, start and end of movement.

The disadvantages of this known solution are the absense of mention of the type of emitted signal and the change in frequency composition with the speed change.

The present invention is intended to mitigate or resolve at least some of the named problems/disadvantages inherent in solutions known from the prior art.

Thus, the proposed technical solution is aimed at eliminating the disadvantages of the modern state of the art and differs from the previously known ones in that the proposed solution adjusts not only the total volume of the sound being reproduced, but also the volume of the individual layers that make up the sound.

Such a solution, first of all, allows to ensure a constant amount of acoustic visibility regardless of the vehicle's speed (at all speeds, the time of fixation by a pedestrian of the vehicle will be the same), secondly, it will make it possible to adjust the amount of acoustic visibility, making the vehicle more or less noticeable to pedestrians, as well as for micro vehicles, thirdly, it allows to make the amount of visibility independent of the type of external background noise (in quiet places, a vehicle will not have excessive visibility, i.e. be too loud, and will not harm the acoustic ecology). These innovations will improve the safety of electric vehicles for pedestrians.

### SUBSTANCE OF INVENTION

The technical task, which the claimed technical solution is aimed to solve, is to improve the acoustic visibility of pedestrians of a moving quiet (electric or hybrid) vehicle (relative to the previous state of the art) by ensuring the same acoustic visibility independent of the following factors: the speed of the vehicle, the nature of the background noise of the environment (city/suburb, road/park) and the time of day (day/night).

The technical result achieved in solving the above technical problem is to ensure the acoustic identification of the vehicle.

In addition, the claimed solution ensures the safety of pedestrians due to the acoustic visibility of a quiet vehicle, namely by changing the timbral and dynamic characteristics, as well as the emission level of the AVAS (Acoustic Vehicle Alert System) system signal depending on the speed of the vehicle, the nature of background environmental noise, and time of day.

The claimed technical result is achieved due to the method of sound alert for vehicles (TS) with a low noise level, containing the stages during which:
a) using external devices installed on the vehicle, input data parameters are obtained which include at least the following information: on activation/deactivation of the vehicle, information on the selected mode of movement of the vehicle, information on the vehicle speed, information on the geolocation zone in which the vehicle is located, information on the current time of day, information on the position of the visibility value controller;
b) a sound data packet containing at least two event sounds, a parking sound, a forward motion sound consisting of four separate layers, and a reverse movement sound is received from the AVAS (Acoustic Vehicle Alert System) computing unit;
c) the received data are processed at the stages a) and b) using a processing module, as a result of which a sound signal is generated for the alert mode depending on the values of the data of the input parameters and the sound data packet, and the alert volume level depending on information on the current time of day, information on the geolocation zone in which the vehicle is located, and the information on the position of the visibility value controller;
d) a sound alerting is carried out using a vehicle speaker system with a set volume and a set sound mode, determined at step c).

In a particular embodiment of the proposed method, the information about the selected vehicle movement mode is selected from the following group: forward vehicle movement, reverse vehicle movement, or parking.

In a particular embodiment of the proposed method, the sound alert mode is selected from the following group: the sound mode of the vehicle activation, the sound mode of the vehicle parking, the sound mode of the forward movement of the vehicle at a speed from 0 to the maximum speed of the vehicle, the sound mode of the reverse movement of the vehicle, the sound mode of the vehicle deactivation.

In a particular embodiment of the proposed method, the sound mode of the vehicle activation is selected based on the input parameters of the data containing the information about the vehicle activation.

In a particular embodiment of the proposed method, the sound mode of the vehicle parking is selected based on the input parameters of the data containing the information about the vehicle parking.

In a particular embodiment of the proposed method, the sound mode of the vehicle forward movement at a speed from 0 to the maximum speed is selected based on the input data parameters containing the information about the value of the vehicle speed.

In a particular embodiment of the proposed method, the sound mode of the vehicle reverse movement is selected based on the input data parameters containing the information on the selected mode of the vehicle reverse movement.

In a particular embodiment of the proposed method, the sound mode of the vehicle deactivation is selected based on the input parameters of the data containing the information on the vehicle deactivation.

In a particular embodiment of the proposed method, four separate layers include a high-frequency layer, a main layer, a low-frequency layer, and a modulation layer.

In a particular embodiment of the proposed method, each layer is processed independently of each other.

### BRIEF DESCRIPTION OF DRAWINGS

The signs and advantages of this technical solution will become obvious from the detailed description below and the attached drawings.

FIG. 1 illustrates the general block diagram of connections of key units with each other and the general principle of operation of the developed algorithm;

FIG. 2 illustrates a block diagram of the input parameters;

FIG. 3 illustrates the sound packet unit;

FIG. 4.1 illustrates the sound packet processing unit. Part 1. Event sounds;

FIG. 4.2 illustrates the sound packet processing unit. Part 2. Parking sound;

FIG. 4.3 illustrates the sound packet processing unit. Part 3. Forward movement sound;

FIG. 4.4 illustrates the sound packet processing unit. Part 4. Reverse movement sound;

FIG. 5 illustrates the output signal processing unit.

### DETAILED DESCRIPTION OF THE INVENTION

The detailed description of the implementation of the invention below provides numerous implementation details intended to provide a clear understanding of the present invention. However, it will be obvious to a qualified specialist in the subject area how the present invention can be used, both with and without these implementation details. In other cases, well-known methods, procedures and components have not been described in detail in order not to complicate the understanding of the features of the present invention.

In addition, it will be clear from the above presentation that the invention is not limited to the above implementation. Numerous possible modifications, changes, variations and substitutions that keep the essence and form of the present invention will be obvious to the specialists qualified in the subject area.

Electric vehicles invade our future and present. More and more companies are coming up with options for their electric vehicles. Electric vehicles, in particular, are becoming famous for their rechargeable engine, which is powered by batteries, unlike a traditional gasoline engine.

The cost of gasoline used in a traditional engine is 60% more than the cost required to charge an electric vehicle (EV) for the same distance traveled by a vehicle of the same size. This cost can be further reduced if you change your vehicle to a vehicle with a solar photovoltaic system or to one with a free charging station.

You can even mount a solar installation on the roof, generate your own electricity and further reduce costs. These vehicles are also well known for their low emissions and have therefore become favorites of many environmentally conscious users.

In addition, they create less noise pollution, which means additional health benefits for everyone, including reduced road rage, anxiety and tension, as well as increase of cognitive abilities.

Reports from the World Health Organization (WHO) also show that exposure to higher environmental noise levels, especially above 53 decibels (dBA), can lead to health problems such as heart problems, high blood pressure and even hearing impairment. Acoustic services operating in many countries of the world monitor the sounds and vibrations produced in the environment.

The permissible noise level varies in different locations of a large city. In the day time, if you are approaching residential buildings, then the permissible noise level shall not be more than 70 dBA. At the night time, it decreases by 10 and reaches 60 dBA.

If you are near hospitals or sanatoriums, the noise level shall not exceed 50 dBA in the morning and 40 dBA at night. This means that electric vehicles are actually a good option to improve the physical health of the population, since they do not make a sound.

However, on the other hand, although it is known that electric vehicles are quieter than conventional ones, they also pose a serious safety threat namely because of this feature.

The noise-suppressing element of electric and hybrid vehicles, especially at low speeds, can be dangerous for pedestrians, cyclists, people with headphones and people with visual or hearing impairments compared to their counterparts with internal combustion engines.

This means that they will not be able to hear a quiet vehicle when it approaches them, and therefore will not be able to protect themselves in response. It is estimated that electric vehicles are 37% more likely to get into accidents with pedestrians.

The statistics of road accidents between electric vehicles and cyclists are strikingly higher −56%. As a result, legislation in many countries now requires vehicles to be equipped with an Acoustic Vehicle Alert System (AVAS), which generates sounds even when vehicles move at speeds less than 20-30 km/h.

In addition, the sounds shall be different both for the vehicle braking and for the vehicle accelerating. This makes it easier for pedestrians to predict the various actions of the vehicle, as well as identify any risk to them.

The claimed technical solution proposes a new approach for the acoustic safety of electric vehicles, namely the creation of an adaptive vehicle alert system designed specifically for electric vehicles such as electric cars, electric vans, electronic scooters, electronic mopeds, electronic bicycles and even other electrified microvehicles.

The claimed solution is a set of key blocks of the developed algorithm for the implementation of a sound alerting method for vehicles with a low noise level.

A method of sound alerting for low-noise vehicles (TS), containing the stages during which:
a) using external devices installed on the vehicle, input data parameters are obtained which include at least the following information: on activation/deactivation of the vehicle, information on the selected mode of movement of the vehicle, information on the vehicle speed, information on the geolocation zone in which the vehicle is located, information on the current time of day, information on the position of the visibility value controller;
b) a sound data packet containing at least two event sounds, a parking sound, a forward motion sound consisting of four separate layers, and a reverse movement sound is received from the AVAS (Acoustic Vehicle Alert System) computing unit;
c) the received data are processed at the stages a) and b) using a processing module, as a result of which a sound signal is generated for the alert mode depending on the values of the data of the input parameters and the sound data packet, and the alert volume level depending on information on the current time of day, information on the geolocation zone in which the vehicle is located, and the information on the position of the visibility value controller;
d) a sound alerting is carried out using a vehicle speaker system with a set volume and a set sound mode, determined at step c).

Wherein, the information on the selected vehicle movement mode is selected from the following group: forward vehicle movement, reverse vehicle movement, or parking.

The sound alert mode is selected from the following group: the sound mode of the vehicle activation, the sound mode of the vehicle parking, the sound mode of the forward movement of the vehicle at a speed from 0 to the maximum speed, the sound mode of the reverse movement of the vehicle, the sound mode of the vehicle deactivation.

The sound mode of vehicle activation is selected based on the input data parameters containing the information on vehicle activation, and the sound mode of vehicle parking is selected based on the input data parameters containing the information on vehicle parking.

The sound mode of the vehicle forward movement at a speed from 0 to the maximum speed is selected based on the input data parameters containing the information on the value of the vehicle speed, and the sound mode of the vehicle reverse movement is selected based on the input data parameters containing the information on the selected mode of the vehicle reverse movement.

The sound mode of the vehicle deactivation is selected based on the input parameters of the data containing the information on the vehicle deactivation.

Four separate layers are the high frequency layer, the main layer, the low frequency layer, and the modulation layer, and each layer is processed independently of each other.

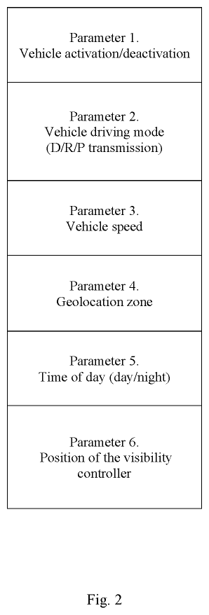

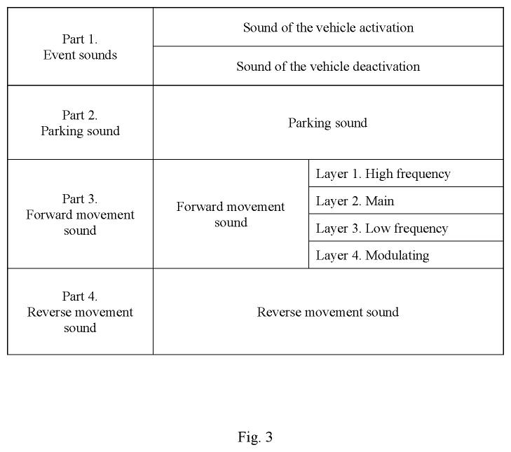

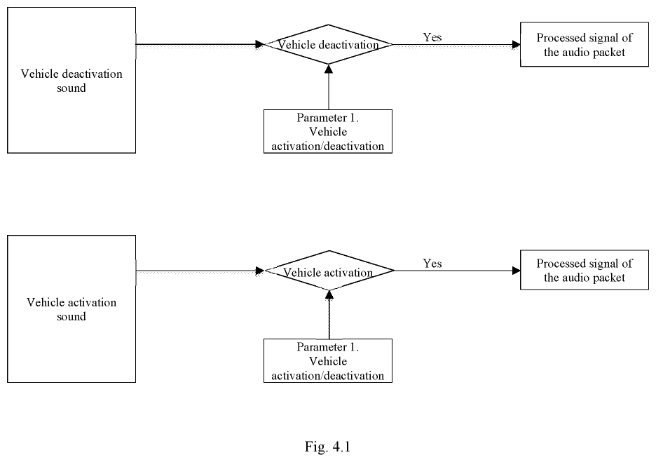

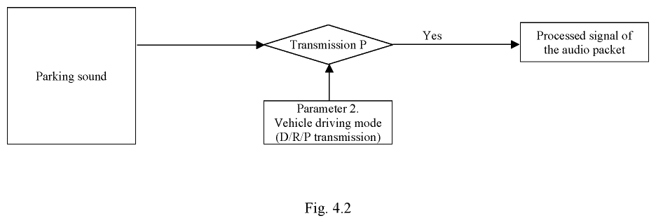

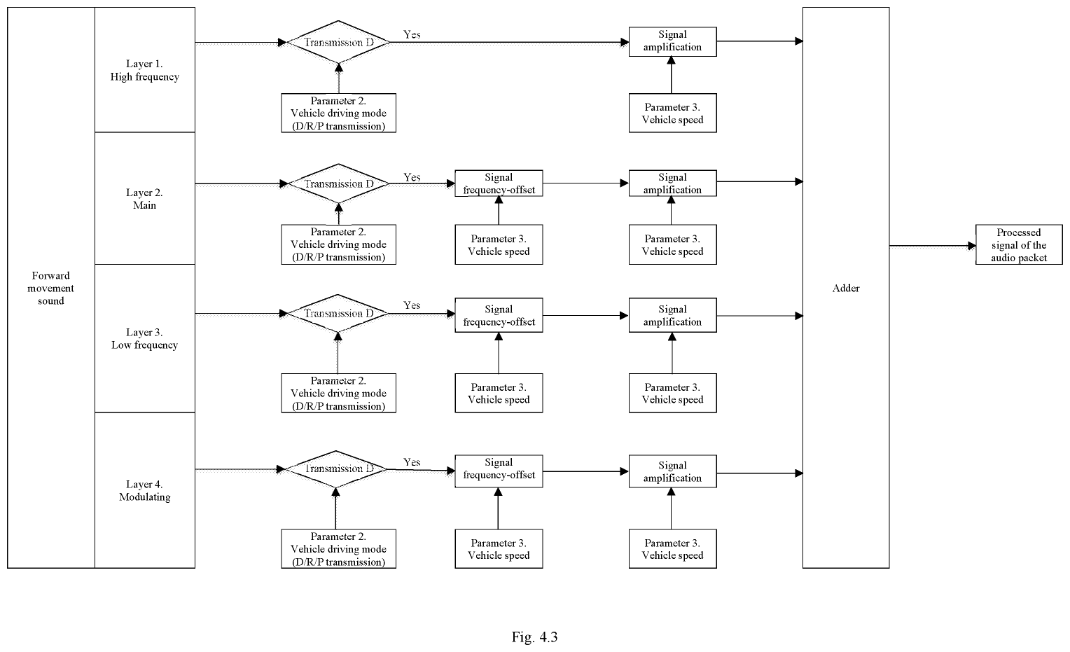

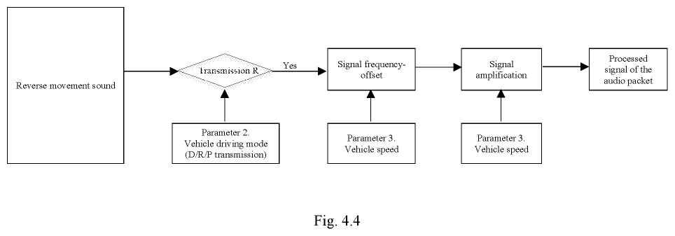

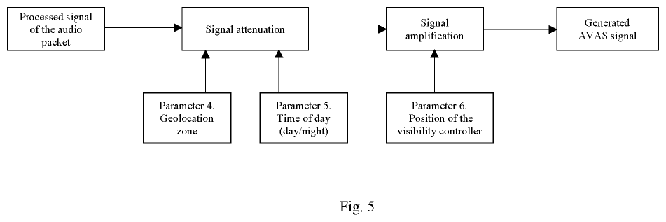

The key units of the developed solution are:
1. Unit of input parameters (FIG. 2);
2. Sound packet unit (FIG. 3);
3. Sound packet processing unit (FIG. 4.1-4.4);
4. Output signal processing unit (FIG. 5).

As shown in FIG. 2 an essential technical feature of the input parameter unit is the composition of the input parameters:
Parameter 1. Information on the position of the vehicle start/stop toggle switch/activation/deactivation);
Parameter 2. Information on the selected driving mode (D/R/P transmission, i.e. forward, reverse or parking);
Parameter 3. Information on the vehicle speed;
Parameter 4. Information on the geolocation zone in which the vehicle is located;
Parameter 5. Information on the current time of day;
Parameter 6. Information on the position of the visibility value controller.

The input parameters listed above affect the solution of the technical problem and the achievement of a technical result, because these parameters pre-determine the choice of parts of the sound packet necessary for reproduction, as well as pre-determine the choice of the processing mode of parts of the sound packet and affect the processing of parts of the sound packet, i.e. they are a control signal for them.

Among the listed essential technical principles, there is no prior art for two input parameters—obtaining the information on the current time of day and obtaining the information on the position of the visibility value controller. These parameters allow to adjust the volume of reproduction of the declared AVAS system's signals depending on the time of day and the position of the visibility value controller, thereby controlling the time of visibility of the vehicle by a pedestrian.

As shown in FIG. 2 an essential technical feature of the sound packet unit is the composition of the sound packet:

There can be multiple sound packets available. One package is selected for reproduction. The sound packet for reproduction can be pre-installed by the manufacturer or selected by a user.
Part 1. Event sounds (activation and deactivation of the vehicle);
Part 2. Parking sound;
Part 3. Forward movement sound;
Part 4. Reverse movement sound.

Part 1 (event sounds) consists of two separate sounds—the sound of activation and deactivation of the vehicle. The other parts of the sound packet each consist of one sound. However, part No. 3, the sound of forward movement, consists of four separate layers. Each part of the sound packet, as well as each layer of the third part of the sound packet, is processed independently of the other parts and layers.

The listed technical features, namely the composition of the sound packet, affect the solution of the technical problem and the achievement of the technical result, because the sounds of the event, the sound of parking and the sound of reverse movement improve the acoustic visibility of the vehicle, and the separate processing of each of the four layers of the sound of forward movement allows for acoustic visibility, independent of the vehicle speed, the nature of the background noise of the environment (city/suburb, road/park) and the time of day (day/night).

Among the listed technical features, for one of the components of the sound packet there is no prior art—the separation of the sound of forward movement into four separate layers, the subsequent processing of which takes place separately.

An essential technical feature of the sound packet processing unit (FIGS. 4.1-4.4) is the principle of its operation, which provides the possibility of parallel processing of four separate parts of the sound packet.

The listed technical features affect the solution of the technical problem and the achievement of a technical result, since the principle of operation of the signal processing unit improves the acoustic visibility of the vehicle and allows to ensure the acoustic visibility independent of the vehicle speed, the nature of the background noise of the environment (city/suburb, road/park) and time of day (day/night).

Among the listed technical features, there is no prior art for the principle of processing of the part of the sound package “sound of forward movement”, which implies parallel processing of four layers of sound at once.

An essential technical feature of the output signal processing unit (FIG. 5) is the presence of an attenuator, the operation of which is controlled by two input parameters—information on the geolocation zone and information on the current time of day, as well as the presence of an amplifier, the operation of which is controlled by one input parameter—information on the position of the visibility value controller.

These technical features affect the solution of the technical problem and the achievement of a technical result, because it allows to ensure the acoustic visibility and the identification of the vehicle, regardless of the nature of the background noise of the environment (city/suburb, road/park) and time of day (day/night), and also allows to adjust the amount of time of visibility of the vehicle by pedestrians.

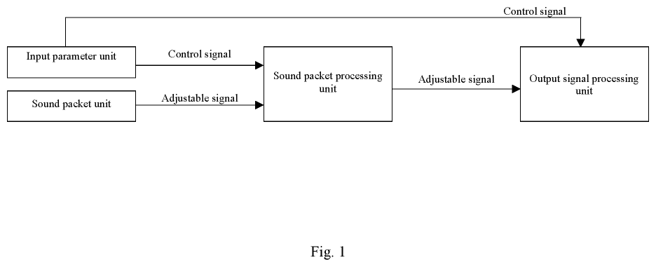

FIG. 1 shows a block diagram illustrating the relationship of key units to each other and the general principle of operation of the developed algorithm. An example of its description is given below.

The sound packet processing unit receives a group of control signals (from the input parameter unit) and an adjustable signal (from the sound packet unit).

An adjustable signal is a sound packet consisting of four separate parts.

The group of control signals includes the following parameters of the input parameter unit:
Information on the position of the vehicle start/stop toggle switch (activation/deactivation);
Parameter 2 (information on the selected driving mode (D/R/P transmission, i.e. forward, reverse or parking));
Parameter 2 (information on the vehicle speed).

Depending on the values of input parameters 1 and 2, the sound packet processing unit selects parts of the sound packet for processing. It is possible to process multiple parts of a sound packet at once.

The processing of parts and layers of the sound packet (frequency shift and signal amplification) occurs depending on the value of output parameter 3.

The sound packet processing unit generates a processed sound packet signal at the output.

The output signal processing unit receives a group of control signals (from the input parameter unit) and an adjustable signal (from the sound packet processing unit).

The adjustable signal is the generated sound packet signal generated by the sound packet processing units.

The group of control signals includes the following parameters of the input parameter unit:
Parameter 4. Information on the geolocation zone in which the vehicle is located;
Parameter 5. Information on the current time of day;
Parameter 6. Information on the position of the visibility value controller.

In the output parameter unit, the adjustable signal is attenuated, the value of which depends on the values of input parameters 4 and 5. Next, the signal is amplified, the value of which depends on the value of input parameter 6.

The output signal processing unit generates an AVAS signal at the output, which is sent to the sound power amplifier and, further, to the terminals of the loudspeaker head.

Below is a detailed description of the composition and principle of operation of each unit.

### Input Parameter Unit

An essential technical feature of the input parameter unit, as it has been mentioned above, is the composition of the input parameters.

Technical features, namely input parameters, affect the solution of a technical problem and the achievement of a technical result, since these parameters pre-determine the choice of parts of the sound packet necessary for processing of parts of the sound packet control the processing of parts of the sound packet and layers of individual sounds of the sound packet.

The composition of the input parameter unit is illustrated in FIG. 2. Parameter values can be received in various technical ways from external devices. Such parameters are received directly from the data buses of the vehicle, these can be buses such as CAN, UART, RS485, RS232 and others, while such parameters can be received from external IoT and telematics devices designed for functions of tracking functions and interaction with the device via the Internet.
Parameter 1. Information on the position of the vehicle start/stop toggle switch/activation/deactivation);
Parameter 2. Information on the selected driving mode (D/R/P transmission, i.e. forward, reverse or parking);
Parameter 3. Information on the vehicle speed;
Parameter 4. Information on the geolocation zone in which the vehicle is located;
Parameter 5. Information on the current time of day;
Parameter 6. Information on the position of the visibility value controller.

### Sound Packet Unit

An essential technical feature of the sound packet unit is the composition of the sound packet.

The listed technical features, namely the composition of the sound packet, affect the solution of the technical problem and the achievement of the technical result, since they improve the acoustic visibility, allow to ensure the acoustic visibility, regardless of the vehicle speed, the nature of the background noise of the environment (city/suburb, road/park) and time of day (day/night).

The composition of the sound packet unit, as it has been mentioned above, is illustrated in FIG. 3. Both one sound packet and several ones can be loaded into the memory of the electronic hardware and computing unit of the AVAS system, with the possibility of selecting a specific sound packet by the user.

Each sound packet consists of four parts:
Part 1. Event sounds (activation and deactivation of the vehicle);
Part 2. Parking sound;
Part 3. Forward movement sound;
Part 4. Reverse movement sound.

Part 1(event sounds) consists of two separate sounds—the sound of activation and deactivation of the vehicle. The other parts of the sound packet each consist of one sound. However, part No. 3, (the sound of forward movement), consists of four separate layers. Each part of the sound packet, as well as each layer of the third part of the sound packet, is processed independently of the other parts and layers.

### Sound Packet Processing Unit

An essential technical feature of the sound packet processing unit is the principle of its operation, which provides the possibility of parallel processing of four separate parts of the sound packet.

The listed technical features affect the solution of the technical problem and the achievement of a technical result, since the principle of operation of the signal processing unit improves the acoustic visibility of the vehicle and allows to ensure the acoustic visibility independent of the vehicle speed, the nature of the background noise of the environment (city/suburb, road/park) and time of day (day/night).

Block diagrams illustrating the principle of processing of different parts of a sound packet, as it has been described above, are shown in FIG. 4.1-4.4.

Depending on the values of input parameters 1 and 2, a part of the sound packet for processing is selected. It is possible to process multiple parts of a sound packet at once.

If parameter 1 takes a value indicating that “the vehicle has been activated”, then the AVAS system starts operation and the “vehicle activation sound” is selected from part 1“Event sounds” of the sound packet. The sound is sent to the output of the sound packet processing unit.

If parameter 1 takes a value indicating that “the vehicle was deactivated”, the “vehicle deactivation sound” is selected from part 1 “Event sounds” of the sound packet. The sound is sent to the output of the sound packet processing unit. After that, the AVAS system stops operation.

If parameter 2 takes a value indicating that the “parking” driving mode is selected, i.e. the P transmission is activated, then part of the sound packet No. 2 is selected. The sound is sent to the output of the sound packet processing unit.

If parameter 2 takes a value indicating that the “forward” driving mode is selected, i.e. the D transmission is activated, then part of the sound packet No. 3 is selected. The selected part of the sound packet consists of four separate layers (i.e. the sound itself consists of four parts): “Layer 1. High-frequency”, “Layer 2. Main”, “Layer 3. Low Frequency” and “Layer 4. Modulated.” Independent parallel processing of each of four layers occurs. For layers 2, 3, 4, the processing includes frequency shift and amplification. For layer No. 1, only amplification is performed. After processing each layer, the signals are sent to the adder. Then, the sound is sent to the output of the sound packet processing unit.

The signal frequency increases with the speed increase. The function of increasing the signal frequency depending on the speed is pre-configured by the developer in the electronic hardware and computing unit of the AVAS system;

The signal voltage amplitude amplification factor increases with the speed increase. The function of increasing the signal amplification factor depending on the speed is pre-configured by the developer in the electronic hardware and computing unit of the AVAS system; An individual function of increasing the signal gain is set for each layer.

If parameter 2 takes a value indicating that the “reverse” driving mode is selected, i.e. the R transmission is activated, then part of the sound packet No. 4 is selected. The sound is sent to the output of the sound packet processing unit. The processing includes the frequency shift and amplification. Then, the sound is sent to the output of the sound packet processing unit.

The signal frequency increases with the speed increase. The function of increasing the signal frequency depending on the speed is pre-configured by the developer in the electronic hardware and computing unit of the AVAS system;

The signal voltage amplitude amplification factor increases with the speed increase. The function of increasing the signal amplification factor depending on the speed is pre-configured by the developer in the electronic hardware and computing unit of the AVAS system;

### Output Signal Processing Unit

An essential technical feature of the output signal processing unit is the presence of an attenuator, the operation of which is controlled by two input parameters—information on the geolocation zone and information on the current time of day, as well as the presence of an amplifier, the operation of which is controlled by one input parameter—information on the position of the visibility value controller.

These technical features affect the solution of the technical problem and the achievement of a technical result, because it allows to ensure the acoustic visibility, regardless of the nature of the background noise of the environment (city/suburb, road/park) and time of day (day/night), and also allows to adjust the amount of time of visibility of the vehicle by pedestrians.

A block diagram illustrating the principle of operation of the output signal processing unit, as described above, is shown in FIG. 5.

In the output signal processing unit, the adjustable signal (the processed signal of the sound packet) is first attenuated, i.e., the signal voltage level decreases, the value of which depends on the values of input parameters 4 and 5.

With the value of parameter 4 “suburb”, attenuation of the signal voltage amplitude occurs at N4 decibels (the value of N4 is preset by the developer in the electronic hardware and computing unit of the AVAS system), and with the value “city”, attenuation does not occur.

With the value of parameter 5 “night”, attenuation of the signal voltage amplitude occurs at N5 decibels (the value of N5 is preset by the developer in the electronic hardware and computing unit of the AVAS system), and at the value “city”, attenuation does not occur.

Next, the adjustable signal the adjustable signal (the processed signal of the sound packet) is amplified. The amount of gain depends on the value of parameter 6 and is proportional to the selected value of visibility.

The generated signal in the output signal processing unit is sent to the sound power amplifier and, further, the terminals of the speaker head and is the signal that the AVAS system reproduces.

In these application materials, the preferred disclosure of the implementation of the claimed technical solution was presented, which shall not be used as limiting other, private embodiments of its implementation, which do not go beyond the scope of the requested scope of legal protection and are obvious to specialists in the relevant field of technology.

1. A method of sound alerting for low-noise vehicles (TS), containing the stages during which:
a) using external devices installed on the vehicle, input data parameters are obtained which include at least the following information: on activation/deactivation of the vehicle, information on the selected mode of movement of the vehicle, information on the vehicle speed, information on the geolocation zone in which the vehicle is located, information on the current time of day, information on the position of the visibility value controller;
b) a sound data packet containing at least two event sounds, a parking sound, a forward motion sound consisting of four separate layers, and a reverse movement sound is received from the AVAS (Acoustic Vehicle Alert System) computing unit;
c) the received data are processed at the stages a) and b) using a processing module, as a result of which a sound signal is generated for the alert mode depending on the values of the data of the input parameters and the sound data packet, and the alert volume level depending on information on the current time of day, information on the geolocation zone in which the vehicle is located, and the information on the position of the visibility value controller;
d) a sound alerting is carried out using a vehicle speaker system with a set volume and a set sound mode, determined at step c).

2. The method of claim 1, characterized by that the information on the selected vehicle movement mode is selected from the following group: forward vehicle movement, reverse vehicle movement, or parking.

3. The method according to claim 1, characterized by the fact that the sound alert mode is selected from the following group: the sound mode of the vehicle activation, the sound mode of the vehicle parking, the sound mode of the forward movement of the vehicle at a speed from 0 to the maximum speed, the sound mode of the reverse movement of the vehicle, the sound mode of the vehicle deactivation.

4. The method according to claim 3, characterized by the fact that the sound mode of activation on the vehicle is selected based on the input parameters of the data containing the information on activation on the vehicle.

5. The method according to claim 3, characterized by the fact that the sound mode of the vehicle parking is selected based on the input parameters of the data containing the information on the vehicle parking.

6. The method according to claim 3, characterized by that the sound mode of the vehicle moving forward at a speed from 0 to the maximum speed is selected based on the input data parameters containing the information on the value of the vehicle speed.

7. The method according to claim 3, characterized by that the sound mode of the vehicle reverse movement mode is selected based on the input data parameters containing the information on the selected mode of the vehicle reverse movement mode.

8. The method according to claim 3, characterized by the fact that the sound mode of deactivation of the vehicle is selected based on the input parameters of the data containing the information on deactivation of the vehicle.

9. The method according to claim 1, characterized by that four separate layers are a high-frequency layer, a main layer, a low-frequency layer, and a modulation layer.

10. The method according to claim 9, characterized by that each layer is processed independently of each other.
